(19) United States
(12) Patent Application Publication
(10) Pub. No.: US 2025/0198482 A1
(43) Pub. Date: Jun. 19, 2025

(54) System for Couplable Uniformly Alloyed Metallic Members with Physical Attribute Visual Indicator Portions

(71) Applicant: Charles Neeter, Bellingham, WA (US)

(72) Inventor: Charles Neeter, Bellingham, WA (US)

(21) Appl. No.: 18/984,628

(22) Filed: Dec. 17, 2024

Related U.S. Application Data
(60) Provisional application No. 63/611,680, filed on Dec. 18, 2023.

(51) Int. Cl. F16G 13/18; C22C 5/02; F16G 15/12; F16G 17/00

(52) U.S. Cl. CPC F16G 13/18; C22C 5/02; F16G 15/12; F16G 17/00

(57) ABSTRACT

A uniformly alloyed metallic member having an inertial amount of metallic alloy including at least one aperture, including an inertial amount visual indicator at least associated with the inertial amount of metallic alloy in terms of weight or mass, and including an alloy visual indicator at least associated with type of the metallic alloy.

### SUMMARY

In one or more aspects a first uniformly alloyed metallic member having an inertial amount of metallic alloy includes (I) a first side; (II) a second side; (III) at least one outer edge portion extending between the first side and the second side; (IV) at least one inner edge portion extending between the first side and the second side; (V) at least one aperture, wherein the at least one inner edge portion bounds at least in part the at least one aperture; (VI) an inertial amount visual indicator at least associated with the inertial amount of metallic alloy, wherein the inertial amount of metallic alloy includes a dominant metal portion of the metallic alloy having an amount larger than any other metal portion of the metallic alloy; and (VII) an alloy visual indicator at least associated with the amount of the dominant metal.

In implementations the at least one aperture includes at least one elongated cross-sectional profile.

In implementations at least one of the first and second sides includes at least one planar portion.

In implementations at least one portion of inertial amount visual indicator is etched into at least one of the first and second sides.

In implementations at least one portion of inertial amount visual indicator is embossed onto at least one of the first and second sides.

In implementations the inertial amount visual indictor includes at least one numerical amount visual indication and at least one inertial unit visual indication.

In implementations the first uniformly alloyed metallic member is configured as a chain link.

In implementations at least one portion of the alloy visual indicator is etched into at least one of the first and second sides.

In implementations at least one portion of the alloy visual indicator is embossed onto at least one of the first and second sides.

In implementations the alloy visual indictor includes at least one purity visual indication and at least one dominant metal visual indication.

In implementations the at least one purity visual indication includes at least one Arabic numeral.

In implementations the at least one dominant metal visual indication is expressed in terms of at least one element symbol.

In implementations the at least one dominant metal visual indication is expressed as “Au” thereby indicating that the dominant metal of the first uniformly alloyed metallic member is gold.

Implementations further include a second uniformly alloyed metallic member having an inertial amount of metallic alloy including (I) a first side; (II) a second side; (III) at least one outer edge portion extending between the first side and the second side; (IV) at least one inner edge portion extending between the first side and the second side; (V) at least one aperture, wherein the at least one inner edge portion bounds at least in part the at least one aperture; (VI) an inertial amount visual indicator at least associated with the inertial amount of metallic alloy, wherein the inertial amount of metallic alloy includes a dominant metal having a fractional portion of the metallic alloy largest than fractional portion of any other metal of the metallic alloy; and (VII) an alloy visual indicator at least associated with the fractional portion of the dominant metal, wherein the first uniformly alloyed metallic member is couplable with the second uniformly alloyed metallic member.

In implementations when the second uniformly alloyed metallic member is coupled with the first uniformly alloyed metallic member, a portion of the second uniformly alloyed metallic member passes through a portion of the at least one aperture of the first uniformly alloyed metallic member, and wherein when the first uniformly alloyed metallic member is coupled with the second uniformly alloyed metallic member, a portion of the first uniformly alloyed metallic member passes through a portion of the at least one aperture of the second uniformly alloyed metallic member.

Implementations further include at least one slot portion extending from a portion of the at least one outer edge portion to a portion of the at least one inner edge portion, wherein the at least one slot portion includes a modifiable width dimension to accommodate coupling the first uniformly alloyed metallic member with the second uniformly alloyed metallic member.

Implementations further include an authentication visual indicator including visual an authentication source visual indication.

In one or more aspects an assembly of continuously coupled uniformly alloyed metallic members with at least one of the uniformly alloyed metallic members includes an inertial amount visual indicator and an alloy type visual indicator.

In one or more aspects an assembly includes (I) a uniformly alloyed metallic member having an inertial amount of metallic alloy including: (A) a first side, (B) a second side, (C) at least one aperture extending from the first side to the second side, (D) an inertial amount visual indicator at least associated with the inertial amount of metallic alloy of the uniformly alloyed metallic member, wherein the inertial amount of metallic alloy of the uniformly alloyed metallic member includes a dominant metal portion larger than any other metal portion of the metallic alloy of the uniformly alloyed metallic member, and (E) an alloy visual indicator at least associated with the dominant metal portion of the uniformly alloyed metallic member; and (II) a uniformly alloyed metallic curvilinear clasp having an inertial amount of metallic alloy, the uniformly alloyed metallic curvilinear clasp including: (A) a first aperture portion, (B) a first gap portion adjacent the first aperture portion, (C) a second aperture portion, (D) a second gap portion adjacent the second aperture portion, (E) an inertial amount visual indicator at least associated with the inertial amount of metallic alloy of the uniformly alloyed metallic curvilinear clasp, wherein the inertial amount of metallic alloy of the uniformly alloyed metallic curvilinear clasp includes a dominant metal portion larger than any other metal portion of the metallic alloy of the uniformly alloyed metallic curvilinear clasp, and (F) an alloy visual indicator at least associated with the dominant metal portion of the uniformly alloyed metallic curvilinear clasp, wherein the first aperture portion of the uniformly alloyed metallic curvilinear clasp is couplable with the uniformly alloyed metallic member, and wherein the at least one aperture of the uniformly alloyed metallic member is couplable with the uniformly alloyed metallic curvilinear clasp.

In addition to the foregoing, other aspects are described in the claims, drawings, and text forming a part of the disclosure set forth herein. Various other aspects are set forth and described in the teachings such as text (e.g., claims and/or detailed description) and/or drawings of the present disclosure. The foregoing is a summary and thus may contain simplifications, generalizations, inclusions, or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 is a top plan view of a first elongated member.

FIG. 2 is a bottom plan view of the first elongated member of FIG. 1.

FIG. 3 is a left side elevational view of the first elongated member of FIG. 1.

FIG. 4 is a right side elevational view of the first elongated member of FIG. 1.

FIG. 5 is a left end elevational view of the first elongated member of FIG. 1.

FIG. 6 is a right end elevational view of the first elongated member of FIG. 1.

FIG. 7 is a top plan view of a second elongated member.

FIG. 8 is a bottom plan view of the second elongated member of FIG. 7.

FIG. 9 is a left side elevational view of the second elongated member of FIG. 7.

FIG. 10 is a right side elevational view of the second elongated member of FIG. 7.

FIG. 11 is a left end elevational view of the second elongated member of FIG. 7.

FIG. 12 is a right end elevational view of the second elongated member of FIG. 7.

FIG. 13 is a top plan view of a curvilinear member.

FIG. 14 is a bottom plan view of the curvilinear member of FIG. 13.

FIG. 15 is a left side elevational view of the curvilinear member of FIG. 13.

FIG. 16 is a right side elevational view of the curvilinear member of FIG. 13.

FIG. 17 is a left end elevational view of the curvilinear member of FIG. 13.

FIG. 18 is a right end elevational view of the curvilinear member of FIG. 13.

FIG. 19 is a bottom perspective view of a partial assembly of the first elongated member of FIG. 1, the second elongated member of FIG. 7, and the curvilinear member of FIG. 13 consecutively coupled together.

FIG. 20 is a view of the partial assembly of FIG. 19 with a bottom plan view the first elongated member of FIG. 1, a side elevational view of the second elongated member of FIG. 7, and a bottom plan view of the curvilinear member of FIG. 13 consecutively coupled together.

FIG. 21 is a view of the partial assembly of FIG. 19 with a side elevational view the first elongated member of FIG. 1, a bottom plan view of the second elongated member of FIG. 7, and a side elevational view of the curvilinear member of FIG. 13 consecutively coupled together.

FIG. 22 is a view of an assembly of a plurality of the first elongated member of FIG. 1, shown in side elevational view, alternating consecutively coupled with a plurality of the second elongated member of FIG. 7, shown in bottom plan view, and the curvilinear member of FIG. 13, shown in side elevational view, coupled to two of the plurality of second elongated members of FIG. 7, shown in bottom plan view.

For a more complete understanding of implementations, reference now is made to the following descriptions taken in connection with the accompanying drawings. The use of the same symbols in different drawings typically indicates similar or identical items, unless context dictates otherwise.

With reference now to the figures, shown are one or more examples of System for Couplable Uniformly Alloyed Metallic Members with Physical Attribute Visual Indicator Portions, articles of manufacture, compositions of matter for same that may provide context, for instance, in introducing one or more processes and/or devices described herein.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here.

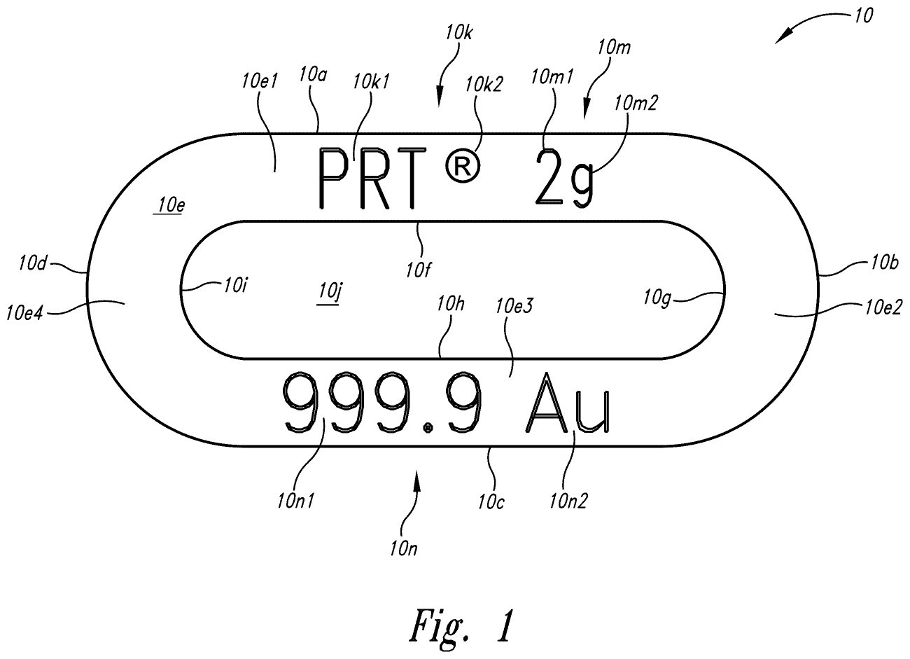

Turning to FIG. 1, depicted therein is a top plan view of first uniformly alloyed metallic member 10. In implementations first uniformly alloyed metallic member 10 includes outer edge portion 10a, outer edge portion 10b, outer edge portion 10c, outer edge portion 10d, first side 10e, inner edge portion 10f, inner edge portion 10g, inner edge portion 10h, inner edge portion 10i, elongated aperture 10j, authentication visual indicator portion 10k, inertial amount visual indicator portion 10m, and alloy type visual indicator portion 10n. In implementations first side 10e includes surface portion 10e1, surface portion 10e2, surface portion 10e3, and surface portion 10e4.

In implementations authentication visual indicator portion 10k (e.g., etched, embossed, molded, etc.) includes authentication source visual indication portion 10k1 (e.g., symbol associated with company or other organization that is the original producer and/or seller, etc.), and trademark registration symbol visual indication portion 10k2 (e.g., trademark owned by company or other organization that is the original producer and/or seller, etc.).

In implementations inertial amount visual indicator portion 10m (e.g., etched, embossed, molded, etc.) in terms of weight or mass of first uniformly alloyed metallic member 10 includes numerical amount visual indication portion 10m1 (e.g., Arabic numeral expression, etc.), and inertial unit visual indication portion 10m2 (e.g., grams (g, gm, gr), grains (gr), ounces (oz), etc.).

In implementations alloy type visual indicator portion 10n (e.g., etched, embossed, molded, etc.) includes purity visual indication portion 10n1 (e.g., 999.9, 99.9, 99.99%, etc.) and dominant metal visual indication portion 10n2 (e.g., Au, Ag, Cu, Pt, Pd, etc.,), which indicates the metal that is of the highest content in a uniform alloy being particularly used. In other words, the dominant metal portion of the metallic alloy is of an amount larger than any other metal portion of the metallic alloy in question. In implementations alloy type visual indicator portion 10n can be expressed by “numeral+kt” such as “24kt” when gold is the dominant metal portion, which accounts for both purity visual indication portion 10n1, and dominant metal visual indication portion 10n2.

In implementations first uniformly alloyed metallic member 10 can be an elongated oval as depicted. In implementations first uniformly alloyed metallic member 10 can be of various shapes including but not limited to rectangular, triangular, irregularly shaped, pentagram, hexagram, heptagram, octagonal, cubic, animal shaped, insect shaped, cartoon shaped, logo shaped, astronomically shaped, climate-symbol shaped, emoji shaped, symbolic shaped, other artistic shaped, etc. for links, beads, charms, pendants, necklaces, earrings, bracelets, rings, broaches, cufflinks, clasps, etc.

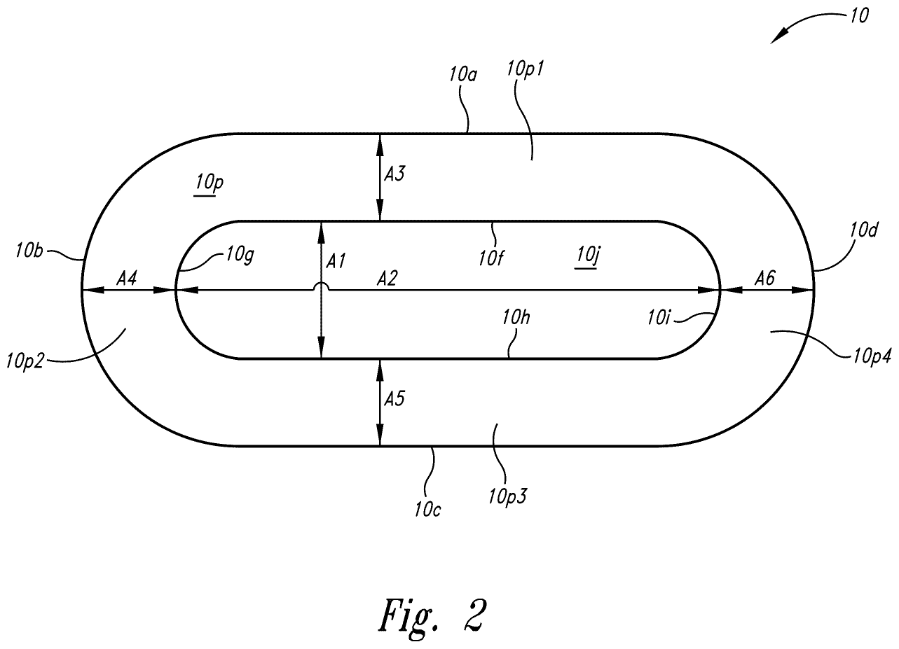

Turning to FIG. 2, depicted therein is a bottom plan view of first uniformly alloyed metallic member 10. In implementations second side 10p includes surface portion 10p1, surface portion 10p2, surface portion 10p3, and surface portion 10p4. In implementations first uniformly alloyed metallic member 10 includes dimension length A1, dimension length A2, dimension length A3, dimension length A4, dimension length A5, and dimension length A6.

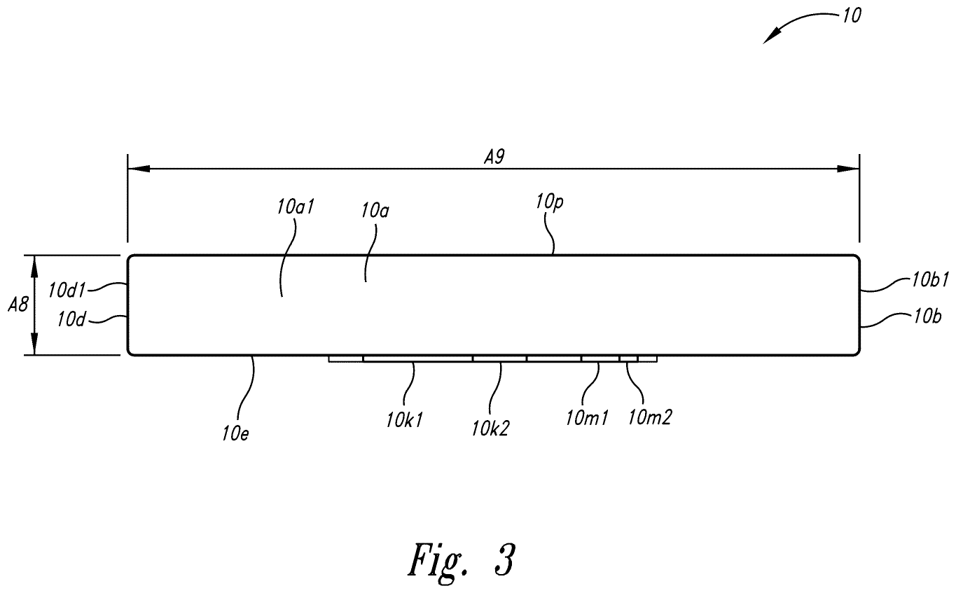

Turning to FIG. 3, depicted therein is a left side elevational view of first uniformly alloyed metallic member 10. In implementations outer edge portion 10a includes outer edge surface portion 10a1, and outer edge surface portion 10a1. In implementations first uniformly alloyed metallic member 10 includes dimension length A8, and dimension length A9.

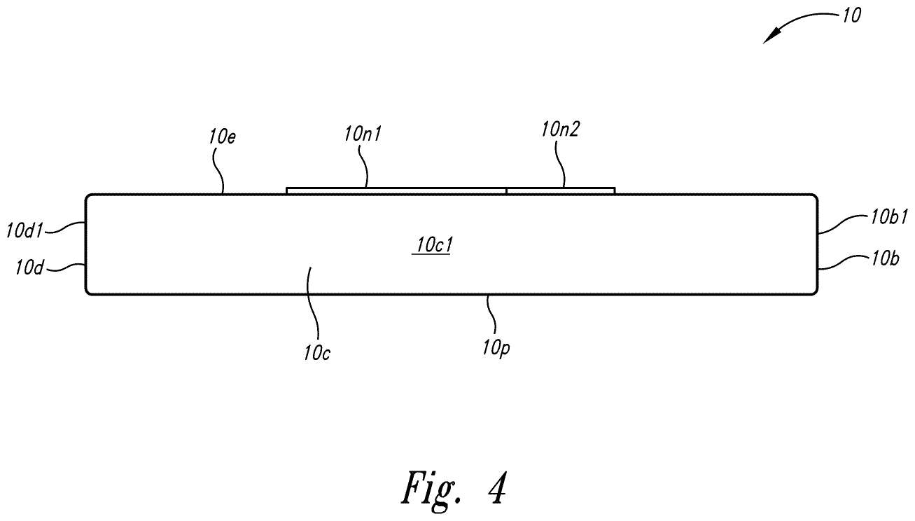

Turning to FIG. 4, depicted therein is a right side elevational view of first uniformly alloyed metallic member 10. In implementations outer edge portion 10c includes outer edge surface portion 10c1.

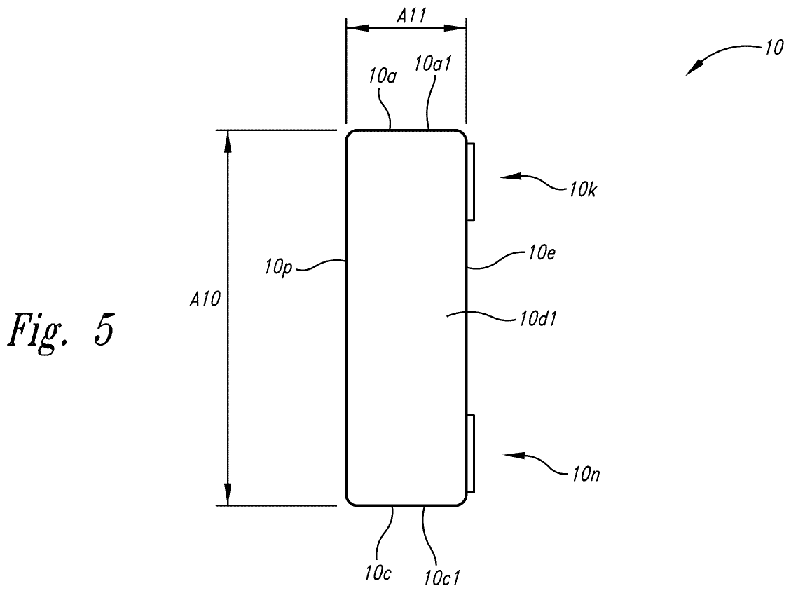

Turning to FIG. 5, depicted therein is a left end elevational view of first uniformly alloyed metallic member 10. In implementations outer edge portion 10d includes outer edge surface portion 10d1. In implementations first uniformly alloyed metallic member 10 includes dimension length A10, and dimension length A11.

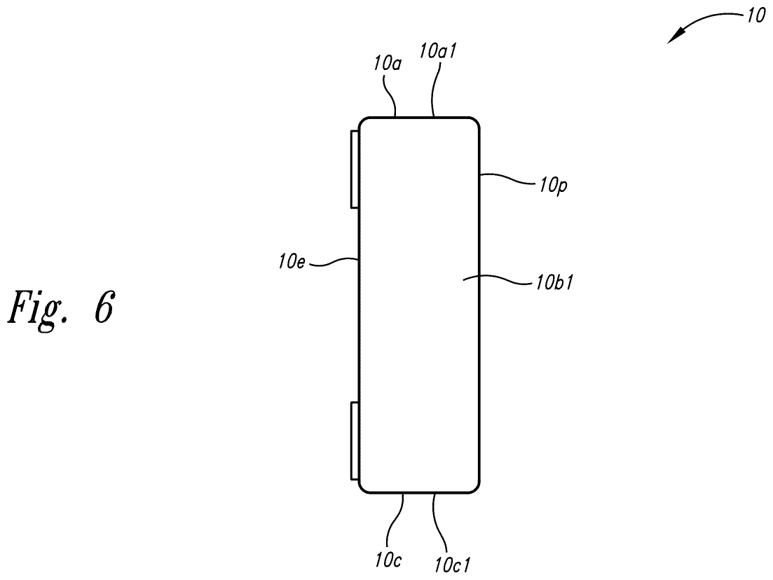

Turning to FIG. 6, depicted therein is a right end elevational view of first uniformly alloyed metallic member 10. In implementations outer edge portion 10b includes outer edge surface portion 10b1.

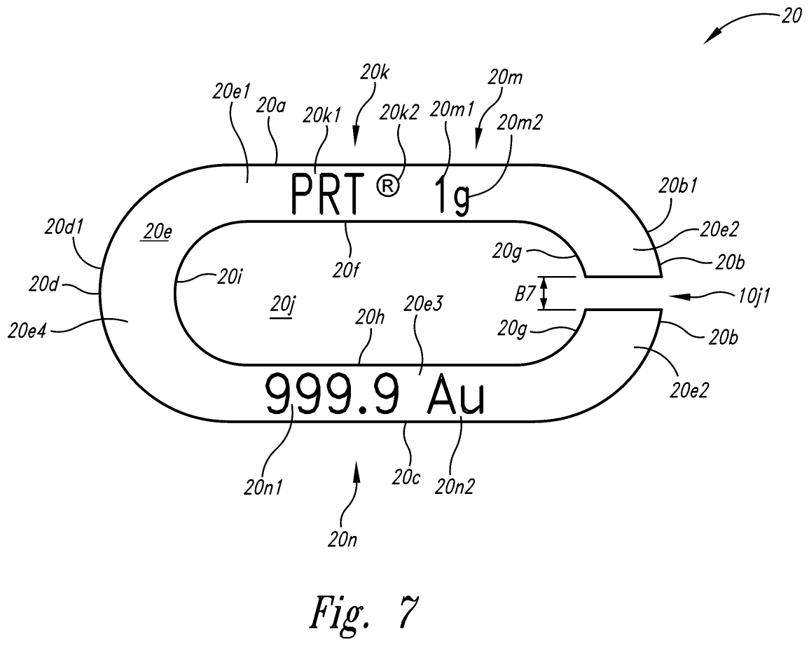

Turning to FIG. 7, depicted therein is a top plan view of second uniformly alloyed metallic member 20. In implementations second uniformly alloyed metallic member 20 includes outer edge portion 20a, outer edge portion 20b, outer edge portion 20c, outer edge portion 20d, first side 20e, inner edge portion 20f, inner edge portion 20g, inner edge portion 20h, inner edge portion 20i, elongated aperture 20j, authentication visual indicator portion 20k, inertial amount visual indicator portion 20m, and alloy type visual indicator portion 20n.

In implementations first side 20e includes surface portion 20e1, surface portion 20e2, surface portion 20e3, and surface portion 20e4. In implementations elongated aperture 20j includes slot portion 20j1 (shown in closed position, but can be forcibly widened and subsequently closed to accommodate initial engagement). In implementations authentication visual indicator portion 20k (e.g., etched, embossed, imprinted, molded, etc.) includes authentication source visual indication portion 20k1 (e.g., symbol associated with company or other organization that is the original producer and/or seller, etc.), and trademark registration symbol visual indication portion 20k2 (e.g., trademark owned by company or other organization that is the original producer and/or seller, etc.).

In implementations inertial amount visual indicator portion 20m (e.g., etched, embossed, molded, etc.) in terms of weight or mass of second uniformly alloyed metallic member 20 includes numerical amount visual indication portion 20m1 (e.g., Arabic numeral expression, etc.), and inertial unit visual indication portion 20m2 (e.g., grams (g, gm, gr), grains (gr), ounces (oz), etc.).

In implementations alloy type visual indicator portion 20n (e.g., etched, embossed, imprinted, molded, etc.) includes purity visual indication portion 20n1 (e.g., 999.9, 99.9, 99.99%, etc.) and dominant metal visual indication portion 20n2 (e.g., Au, Ag, Cu, Pt, Pd, etc.,), which indicates the metal that is of the highest content in a uniform alloy being particularly used. In other words, the dominant metal portion of the metallic alloy is of an amount larger than any other metal portion of the metallic alloy in question. In implementations alloy type visual indicator portion 20n can be expressed by “numeral+kt” such as “24kt” when gold is the dominant metal portion, which accounts for both purity visual indication portion 20n1, and dominant metal visual indication portion 20n2.

In implementations second uniformly alloyed metallic member 20 can be an elongated oval as depicted. In implementations second uniformly alloyed metallic member 20 can be of various shapes including but not limited to rectangular, triangular, irregularly shaped, pentagram, hexagram, heptagram, octagonal, cubic, animal shaped, insect shaped, cartoon shaped, logo shaped, astronomically shaped, climate-symbol shaped, emoji shaped, symbolic shaped, other artistic shaped, etc. for links, beads, charms, pendants, necklaces, earrings, bracelets, rings, broaches, cufflinks, clasps, etc.

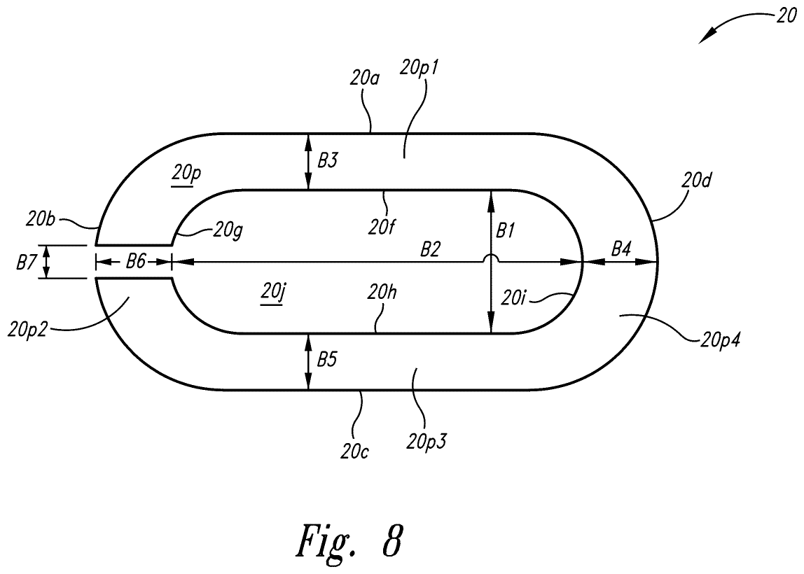

Turning to FIG. 8, depicted therein is a bottom plan view of second uniformly alloyed metallic member 20. In implementations second side 20p includes surface portion 20p1, surface portion 20p2, surface portion 20p3, and surface portion 20p4. In implementations second uniformly alloyed metallic member 20 includes dimension length B1, dimension length B2, dimension length B3, dimension length B4, dimension length B5, and dimension length B6.

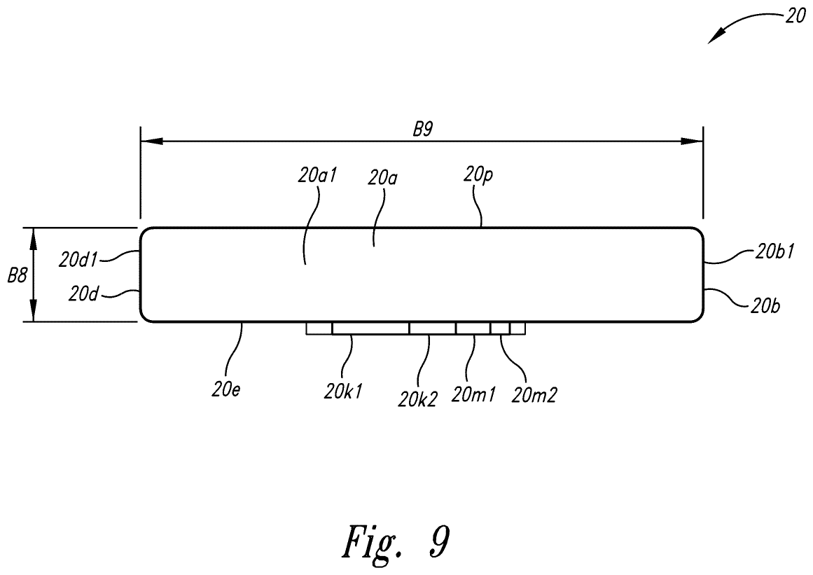

Turning to FIG. 9, depicted therein is a left side elevational view of second uniformly alloyed metallic member 20. In implementations outer edge portion 20a includes outer edge surface portion 20a1. In implementations second uniformly alloyed metallic member 20 includes dimension length B8 and dimension length B9.

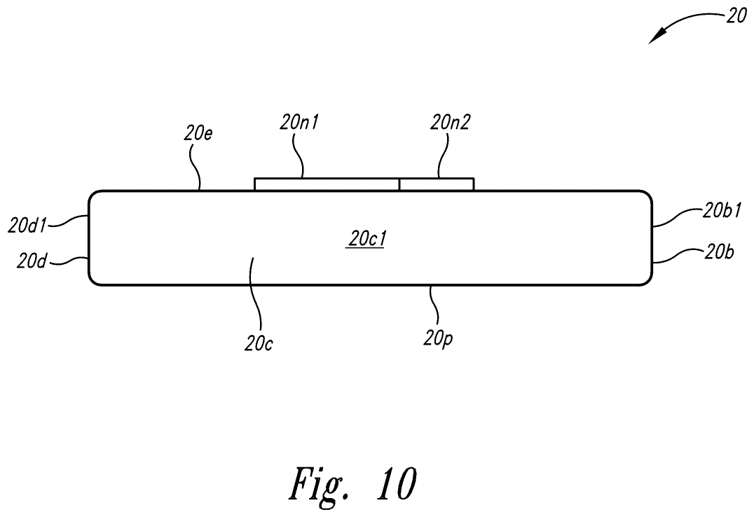

Turning to FIG. 10, depicted therein is a right side elevational view of second uniformly alloyed metallic member 20. In implementations outer edge portion 20c includes outer edge surface portion 20c1.

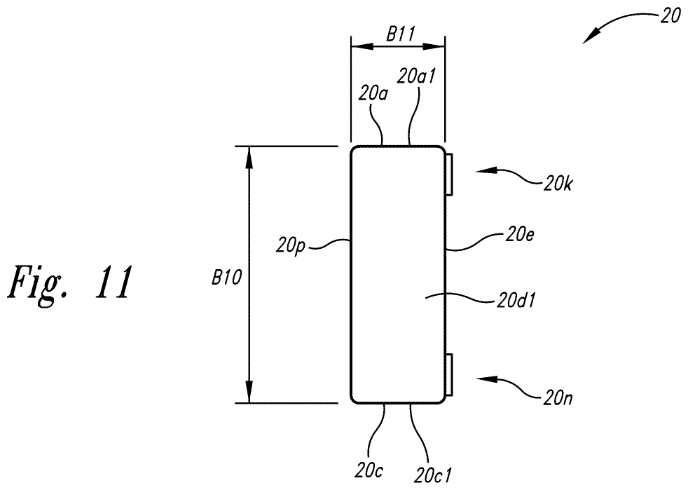

Turning to FIG. 11, depicted therein is a left end elevational view of second uniformly alloyed metallic member 20. In implementations outer edge portion 20d includes outer edge surface portion 20d1. In implementations second uniformly alloyed metallic member 20 includes dimension length B10 and dimension length B11.

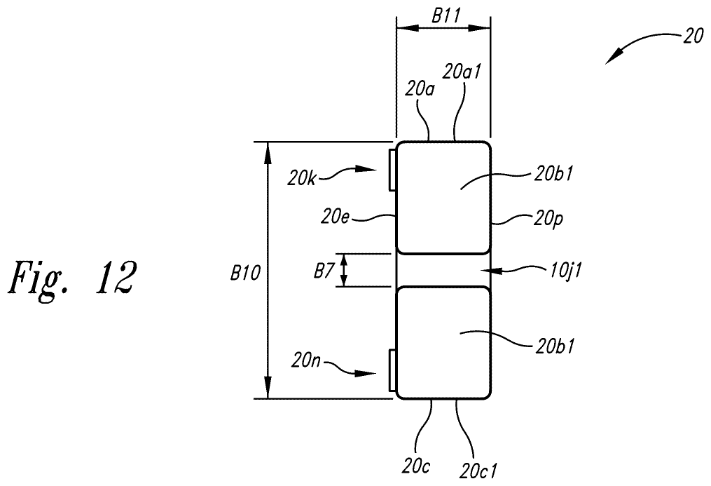

Turning to FIG. 12, depicted therein is a right end elevational view of second uniformly alloyed metallic member 20. In implementations outer edge portion 20b includes outer edge surface portion 20b1.

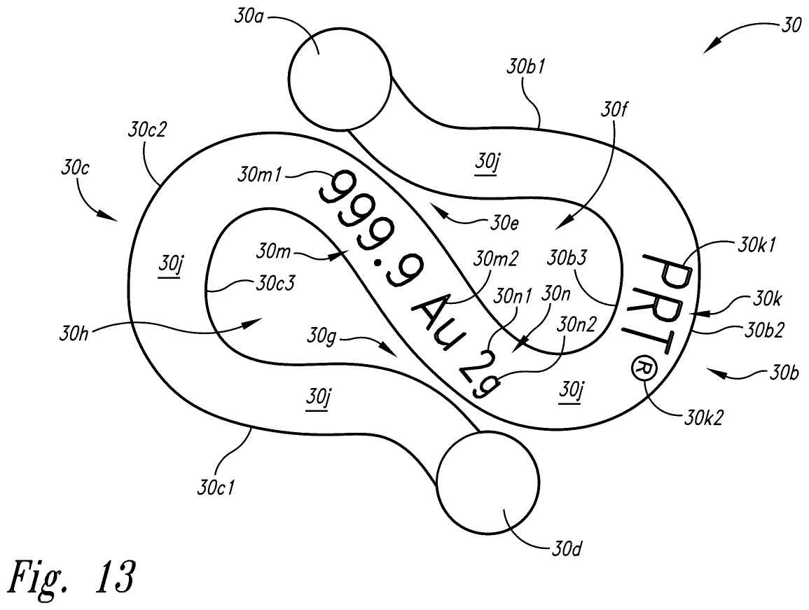

Turning to FIG. 13, depicted therein is a top plan view of uniformly alloyed metallic curvilinear clasp 30. In implementations uniformly alloyed metallic curvilinear clasp 30 includes end portion 30a, switchback portion 30b, switchback portion 30c, end portion 30d, gap portion 30e (shown in closed position, but can be forcibly widened and subsequently closed to accommodate initial engagement), aperture portion 30f, gap portion 30g (shown in closed position, but can be forcibly widened and subsequently closed to accommodate initial engagement), aperture portion 30h, front side 30j, authentication visual indicator portion 30k, alloy type visual indicator portion 30m, and inertial amount visual indicator portion 30n.

In implementations switchback portion 30c includes outer edge portion 30cl, outer edge portion 30c2, and inner edge portion 30c3. In implementations authentication visual indicator portion 30k (e.g., etched, embossed, imprinted, molded, etc.) includes authentication source visual indication portion 30k1 (e.g., symbol associated with company or other organization that is the original producer and/or seller, etc.), and trademark registration symbol visual indication portion 30k2 (e.g., trademark owned by company or other organization that is the original producer and/or seller, etc.).

In implementations alloy type visual indicator portion 30m (e.g., etched, embossed, imprinted, molded, etc.) includes purity visual indication portion 30m1 (e.g., 999.9, 99.9, 99.99%, etc.) and dominant metal visual indication portion 30m2 (e.g., Au, Ag, Cu, Pt, Pd, etc.,), which indicates the metal that is of the highest content in a uniform alloy being particularly used. In other words, the dominant metal portion of the metallic alloy is of an amount larger than any other metal portion of the metallic alloy in question. In implementations alloy type visual indicator portion 30m can be expressed by “numeral+kt” such as “24kt” when gold is the dominant metal portion, which accounts for both purity visual indication portion 30m1, and dominant metal visual indication portion 30m2.

In implementations inertial amount visual indicator portion 30n (e.g., etched, embossed, imprinted, molded, etc.).) in terms of weight or mass of uniformly alloyed metallic curvilinear clasp 30 includes numerical amount visual indication portion 30n1 (e.g., Arabic numeral expression, etc.), and inertial unit visual indication portion 30n2 (e.g., grams (g, gm, gr), grains (gr), ounces (oz), etc.).

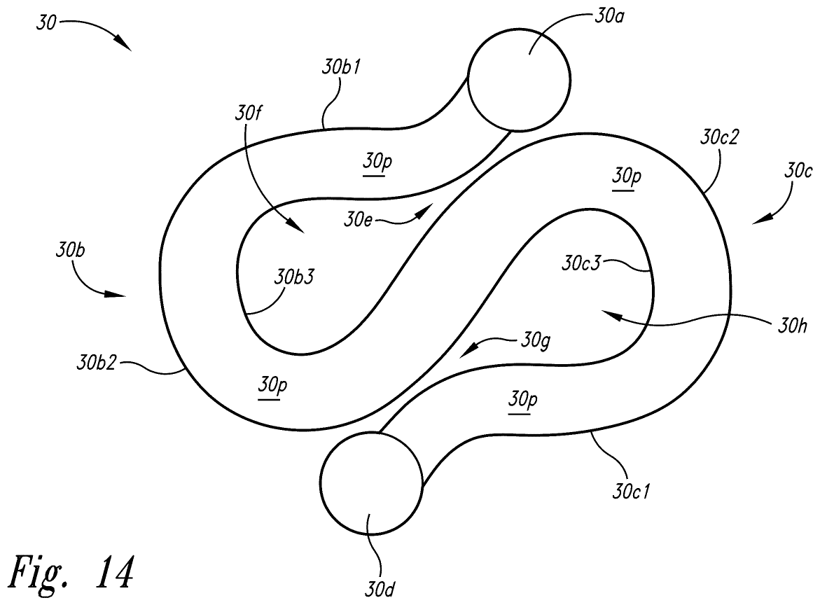

Turning to FIG. 14, depicted therein is a bottom plan view of uniformly alloyed metallic curvilinear clasp 30. In implementations uniformly alloyed metallic curvilinear clasp 30 includes back side 30p.

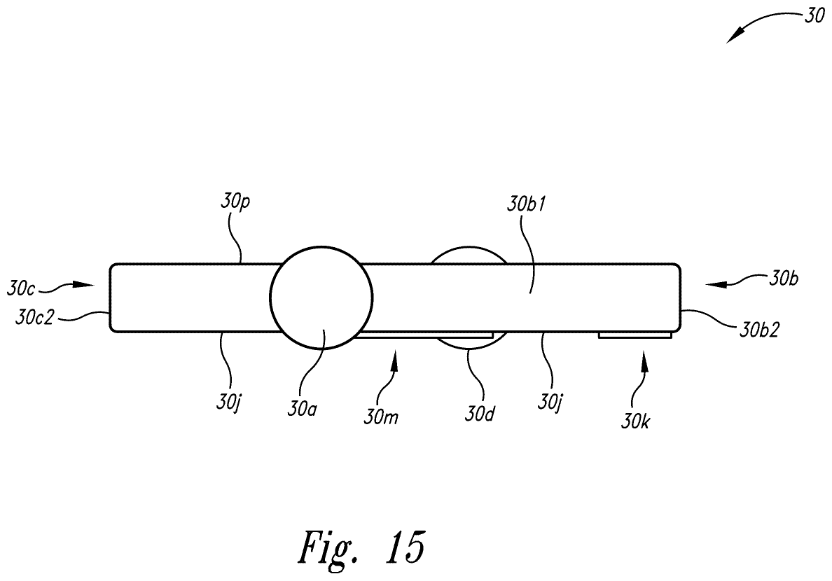

Turning to FIG. 15, depicted therein is a left side elevational view of uniformly alloyed metallic curvilinear clasp 30. In implementations uniformly alloyed metallic curvilinear clasp 30 includes dimension length C1.

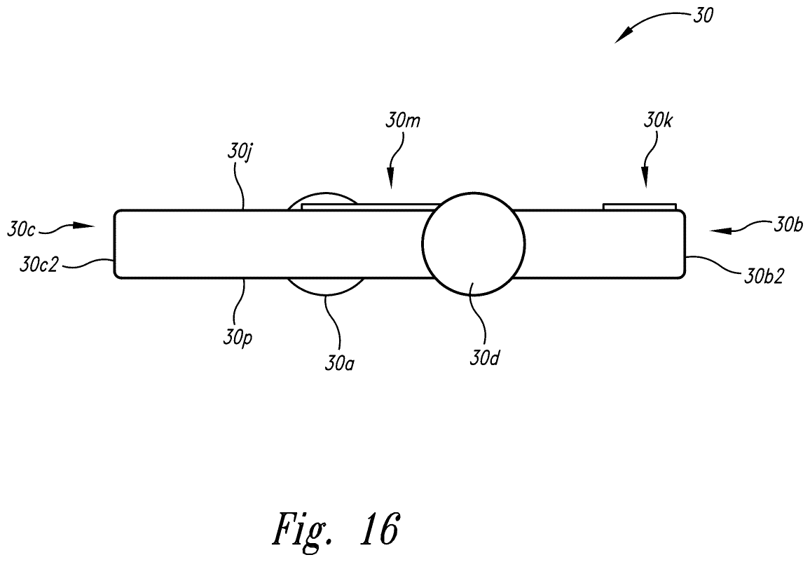

Turning to FIG. 16, depicted therein is a right side elevational view of uniformly alloyed metallic curvilinear clasp 30.

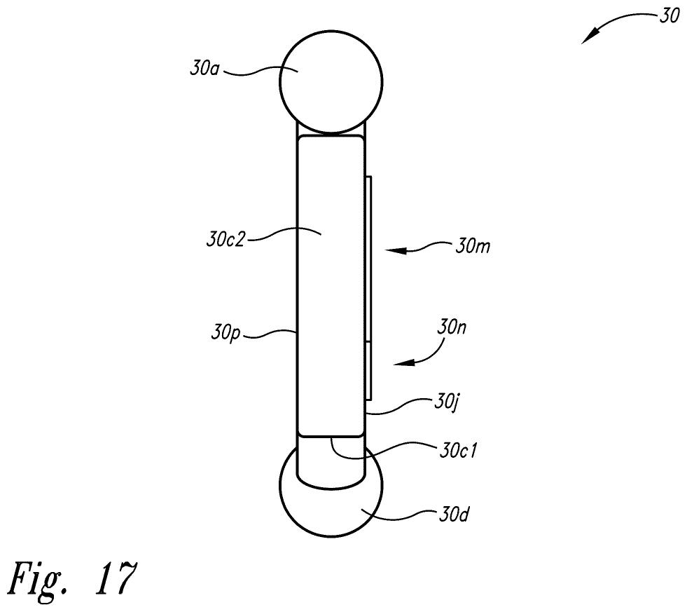

Turning to FIG. 17, depicted therein is a left end elevational view of uniformly alloyed metallic curvilinear clasp 30.

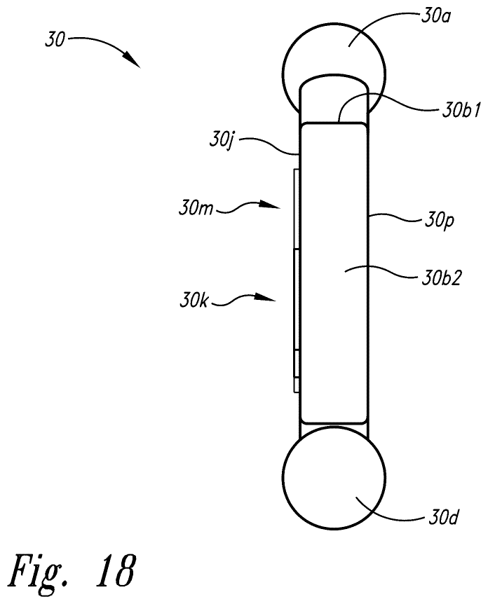

Turning to FIG. 18, depicted therein is a right end elevational view of uniformly alloyed metallic curvilinear clasp 30.

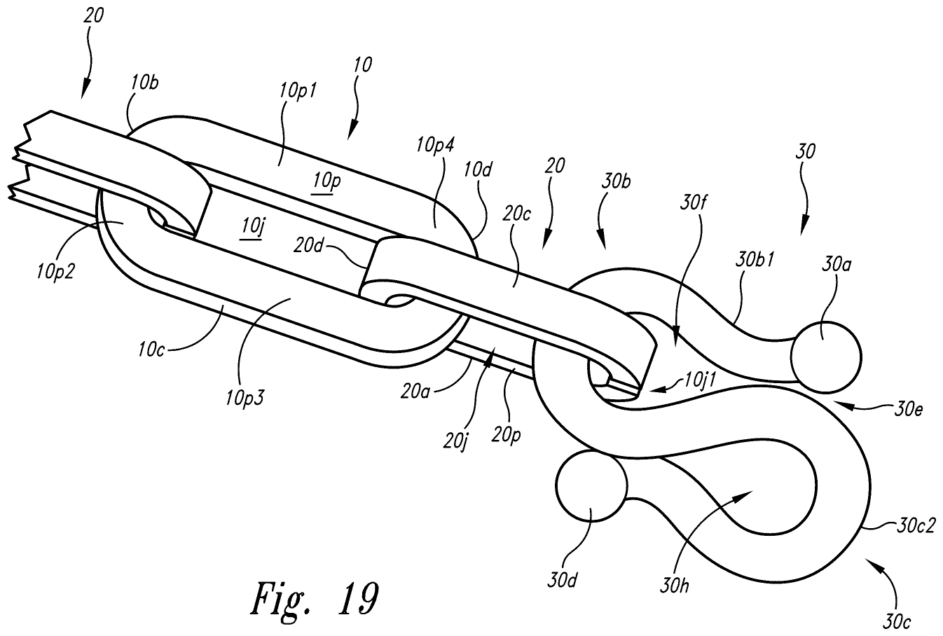

Turning to FIG. 19, depicted therein is a bottom perspective view of a partial assembly of first uniformly alloyed metallic member 10, second uniformly alloyed metallic member 20, and uniformly alloyed metallic curvilinear clasp 30 consecutively coupled together.

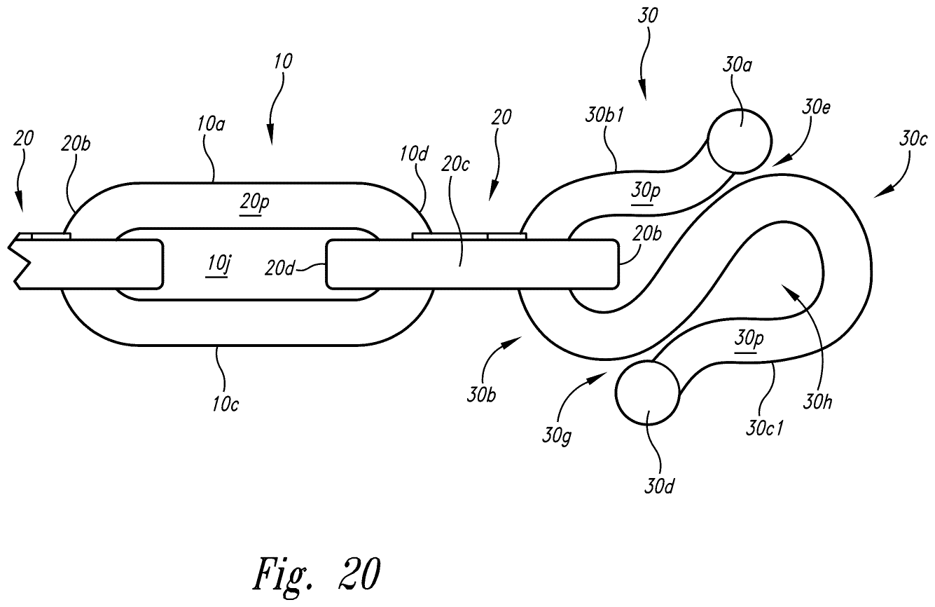

Turning to FIG. 20, depicted therein is a view of the partial assembly of FIG. 19 with a bottom plan view first uniformly alloyed metallic member 10, a side elevational view of second uniformly alloyed metallic member 20, and a bottom plan view of uniformly alloyed metallic curvilinear clasp 30 consecutively coupled together.

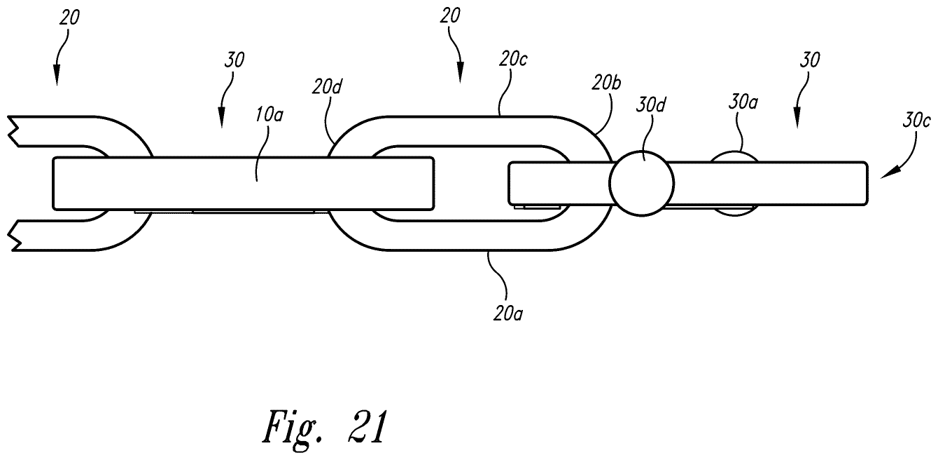

Turning to FIG. 21, depicted therein is a view of the partial assembly of FIG. 19 with a side elevational view first uniformly alloyed metallic member 10, a bottom plan view of second uniformly alloyed metallic member 20, and a side elevational view of uniformly alloyed metallic curvilinear clasp 30 consecutively coupled together.

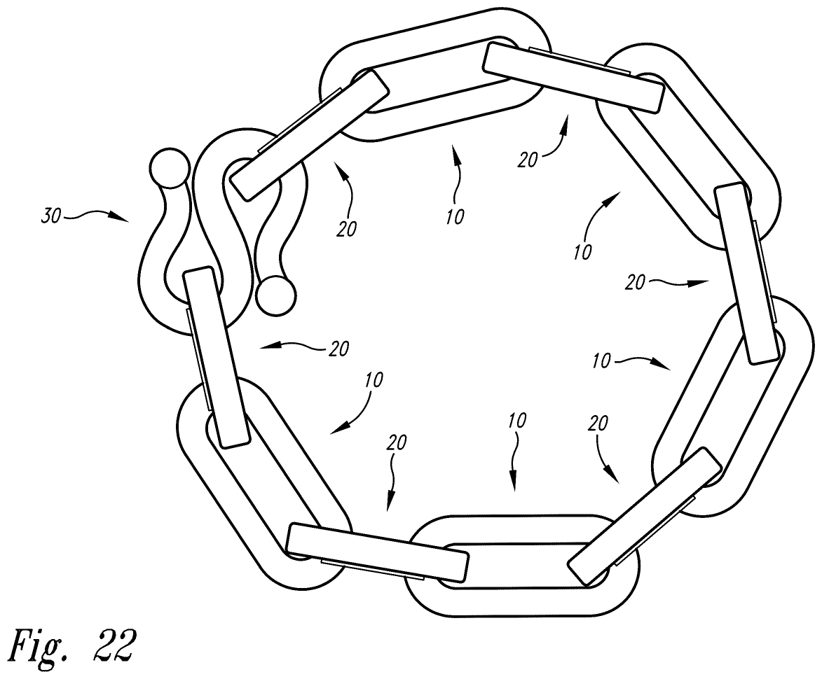

Turning to FIG. 22, depicted therein is a view of an assembly of a plurality of first uniformly alloyed metallic member 10, shown in side elevational view, alternating consecutively coupled with a plurality of second uniformly alloyed metallic member 20, shown in bottom plan view, and uniformly alloyed metallic curvilinear clasp 30, shown in side elevational view, coupled to two of the plurality of second uniformly alloyed metallic member 20, shown in bottom plan view.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A first uniformly alloyed metallic member having an inertial amount of metallic alloy, the first uniformly alloyed metallic member comprising:
(I) a first side;
(II) a second side;
(III) at least one outer edge portion extending between the first side and the second side;
(IV) at least one inner edge portion extending between the first side and the second side;
(V) at least one aperture, wherein the at least one inner edge portion bounds at least in part the at least one aperture;
(VI) an inertial amount visual indicator portion at least associated with the inertial amount of metallic alloy,
wherein the inertial amount of metallic alloy includes a dominant metal portion of the metallic alloy having an amount larger than any other metal portion of the metallic alloy; and
(VII) an alloy visual indicator portion at least associated with the amount of the dominant metal portion.

2. The first uniformly alloyed metallic member of claim 1,
wherein the at least one aperture includes at least one elongated cross-sectional profile.

3. The first uniformly alloyed metallic member of claim 1,
wherein at least one of the first and second sides includes at least one planar portion.

4. The first uniformly alloyed metallic member of claim 1,
wherein at least one portion of inertial amount visual indicator portion is etched into at least one of the first and second sides.

5. The first uniformly alloyed metallic member of claim 1,
wherein at least one portion of inertial amount visual indicator portion is embossed onto at least one of the first and second sides.

6. The first uniformly alloyed metallic member of claim 1,
wherein the inertial amount visual indictor portion includes at least one numerical amount visual indication portion and at least one inertial unit visual indication portion.

7. The first uniformly alloyed metallic member of claim 6,
wherein the at least one inertial unit visual indication portion is associated with mass of the first uniformly alloyed metallic member expressed in gram mass unit.

8. The first uniformly alloyed metallic member of claim 1,
wherein the first uniformly alloyed metallic member is configured as a chain link.

9. The first uniformly alloyed metallic member of claim 1,
wherein at least one portion of the alloy visual indicator portion is etched into at least one of the first and second sides.

10. The first uniformly alloyed metallic member of claim 1,
wherein at least one portion of the alloy visual indicator portion is embossed onto at least one of the first and second sides.

11. The first uniformly alloyed metallic member of claim 1,
wherein the alloy visual indictor portion includes at least one purity visual indication portion and at least one dominant metal visual indication portion.

12. The first uniformly alloyed metallic member of claim 11,
wherein the at least one purity visual indication portion includes at least one Arabic numeral.

13. The first uniformly alloyed metallic member of claim 11,
wherein the at least one dominant metal visual indication portion is expressed in terms of at least one element symbol.

14. The first uniformly alloyed metallic member of claim 11,
wherein the at least one dominant metal visual indication portion is expressed as “Au” thereby indicating that the dominant metal portion of the first uniformly alloyed metallic member is gold.

15. The first uniformly alloyed metallic member of claim 1, further including
a second uniformly alloyed metallic member having an inertial amount of metallic alloy, the second uniformly alloyed metallic member comprising:
(I) a first side;
(II) a second side;
(III) at least one outer edge portion extending between the first side and the second side;
(IV) at least one inner edge portion extending between the first side and the second side;
(V) at least one aperture, wherein the at least one inner edge portion bounds at least in part the at least one aperture;
(VI) an inertial amount visual indicator at least associated with the inertial amount of metallic alloy,
wherein the inertial amount of metallic alloy includes a dominant metal portion having a fractional portion of the metallic alloy largest than fractional portion of any other metal of the metallic alloy; and
(VII) an alloy visual indicator at least associated with the fractional portion of the dominant metal portion,
wherein the first uniformly alloyed metallic member is couplable with the second uniformly alloyed metallic member.

16. The first uniformly alloyed metallic member of claim 15,
wherein when the second uniformly alloyed metallic member is coupled with the first uniformly alloyed metallic member, a portion of the second uniformly alloyed metallic member passes through a portion of the at least one aperture of the first uniformly alloyed metallic member, and
wherein when the first uniformly alloyed metallic member is coupled with the second uniformly alloyed metallic member, a portion of the first uniformly alloyed metallic member passes through a portion of the at least one aperture of the second uniformly alloyed metallic member.

17. The first uniformly alloyed metallic member of claim 15, further including
at least one slot portion extending from a portion of the at least one outer edge portion to a portion of the at least one inner edge portion,
wherein the at least one slot portion includes a modifiable width dimension to accommodate coupling the first uniformly alloyed metallic member with the second uniformly alloyed metallic member.

18. The first uniformly alloyed metallic member of claim 1, further including
an authentication visual indicator including visual an authentication source visual indication.

19. An assembly of continuously coupled uniformly alloyed metallic members with at least one of the uniformly alloyed metallic members including an inertial amount visual indicator and an alloy type visual indicator.

20. An assembly comprising:
(I) a uniformly alloyed metallic member having an inertial amount of metallic alloy, the uniformly alloyed metallic member including:
(A) a first side,
(B) a second side,
(C) at least one aperture extending from the first side to the second side,
(D) an inertial amount visual indicator at least associated with the inertial amount of metallic alloy of the uniformly alloyed metallic member,
wherein the inertial amount of metallic alloy of the uniformly alloyed metallic member includes a dominant metal portion larger than any other metal portion of the metallic alloy of the uniformly alloyed metallic member, and
(E) an alloy visual indicator at least associated with the dominant metal portion of the uniformly alloyed metallic member; and
(II) a uniformly alloyed metallic curvilinear clasp having an inertial amount of metallic alloy, the uniformly alloyed metallic curvilinear clasp including:
(A) a first aperture portion,
(B) a first gap portion adjacent the first aperture portion,
(C) a second aperture portion,
(D) a second gap portion adjacent the second aperture portion,
(E) an inertial amount visual indicator at least associated with the inertial amount of metallic alloy of the uniformly alloyed metallic curvilinear clasp,
wherein the inertial amount of metallic alloy of the uniformly alloyed metallic curvilinear clasp includes a dominant metal portion larger than any other metal portion of the metallic alloy of the uniformly alloyed metallic curvilinear clasp, and
(F) an alloy visual indicator at least associated with the dominant metal portion of the uniformly alloyed metallic curvilinear clasp,
wherein the first aperture portion of the uniformly alloyed metallic curvilinear clasp is couplable with the uniformly alloyed metallic member, and
wherein the at least one aperture of the uniformly alloyed metallic member is couplable with the uniformly alloyed metallic curvilinear clasp.
